(19) United States
(12) Patent Application Publication
(10) Pub. No.: US 2007/0071597 A1
(43) Pub. Date: Mar. 29, 2007

(54) High pressure first stage turbine and seal assembly

(75) Inventor: Michael Earl Montgomery, Niskayuna, NY (US)

Correspondence Address: JOHN S. BEULICK (17851), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/237,230

(22) Filed: Sep. 28, 2005

(51) Int. Cl. F03B 11/00

(52) U.S. Cl. 415/174.5

(57) ABSTRACT

A high pressure first stage turbine and seal assembly are described. In one embodiment, a high pressure turbine section is provided. The turbine section includes at least one stage, at least one rotor and a bucket assembly. The bucket assembly includes a bucket and an attachment fixture. The stage has a high root reaction during operation. An intermediate space is between the bucket assembly and a stationary component of the turbine section. A seal is provided between the stationary member and the rotor to facilitate preventing leakage from the intermediate space toward an end of the stage. Steam balance holes are provided in the rotor or the bucket to facilitate feeding steam towards an end of the turbine stage.

### BACKGROUND OF THE INVENTION

The present invention relates generally to rotary machines and, more particularly, to a high pressure first stage turbine.

At least some steam turbines have a defined steam path which includes, in serial-flow relationship, a steam inlet, a turbine, and a steam outlet. Steam leakage, either out of the steam path or into the steam path, from an area of higher pressure to an area of lower pressure may adversely affect an operating efficiency of the turbine. For example, steam-path leakage in the turbine between a rotating rotor shaft of the turbine and a circumferentially surrounding turbine casing, may lower the efficiency of the turbine.

To facilitate minimizing steam-path leakage to the atmosphere, at least some known steam turbines use a packing casing that includes a plurality of labyrinth seals. Some known labyrinth seals include longitudinally spaced-apart rows of labyrinth seal teeth which are used to seal against pressure differentials that may be present in the steam turbine. Seal members, such as brush seals or leaf seals, may also be used in an attempt to reduce leakage through a gap defined between two components.

In an attempt to reduce leakage of steam from the root of the stage into the end of the section, low reaction roots have been used. Generally, a low reaction root causes the leakage steam at the root to be at a reduced pressure as compared to the main flow pressure. Negative reaction and steam balance holes induce steam from the discharge of the stage through the steam balance holes to feed the leakage path. As a result, most of the steam that leaks has already been expanded through the stage and produced useful work. Such low reaction roots, however, may result in less efficient expansion of the steam than high reaction roots. A high degree of reaction facilitates ensuring there is a positive pressure on the rotating blade at all diameters, which in turn facilitates efficient expansion of the steam.

Another known approach is to use steam from a space between a nozzle and a bucket to feed the leakage path. The leakage path through the end section is decreased because the nozzle decreases the steam pressure, thus decreasing the source pressure for the leakage path. However, none of the steam used to feed the leakage path expands through the bucket to produce useful work. In addition, in-service variations of the reaction of the stage due to wear and tear may impact other machine parameters in a disadvantageous manner.

Yet another known approach utilizes high reaction stage roots with the leakage flow fed from the bowl of the stage. However, the bowl pressure is higher than the intermediate pressure at the roots. As a result, the source pressure for the leakage flow is higher and the leakage flow will increase, which leads to decreased efficiency.

### BRIEF DESCRIPTION OF THE INVENTION

In one aspect, a high pressure turbine section is provided. The turbine section includes at least one stage, at least one a rotor, a nozzle, and a bucket assembly. The bucket assembly includes a bucket and an attachment fixture. The stage has a high root reaction during operation. An intermediate space is between the bucket assembly and a stationary component of the turbine section. A seal is provided between the stationary member and the rotor to facilitate preventing leakage from the intermediate space toward an end of the section.

In another aspect, a seal assembly for a turbine section is provided. The turbine section includes an intermediate space between a bucket assembly, a stationary member and a rotor. The seal assembly includes a seal between the stationary member and the rotor to facilitate preventing leakage from the intermediate space toward an end of the turbine section, and wheel steam balance holes providing a path for shell steam to feed the section end.

In yet another aspect, a rotary machine is provided. The rotary machine includes at least one stage, at least one rotor, a nozzle, and a bucket assembly. The bucket assembly includes a bucket and an attachment fixture. The stage of the rotary machine has a high root reaction during operation. An intermediate space is between the bucket assembly and a stationary component of the turbine section, and a seal is between the stationary member and the rotor to facilitate preventing leakage from the intermediate space toward an end of the section.

### BRIEF DESCRIPTION OF THE DRAWINGS

FIG. 1 is a schematic illustration of an exemplary opposed flow High Pressure (HP)/Intermediate Pressure (IP) steam turbine;

FIG. 2 is a schematic illustration of a portion of a high pressure turbine section; and

FIG. 3 is a schematic illustration of a portion of an alternative high pressure turbine section.

### DETAILED DESCRIPTION OF THE INVENTION

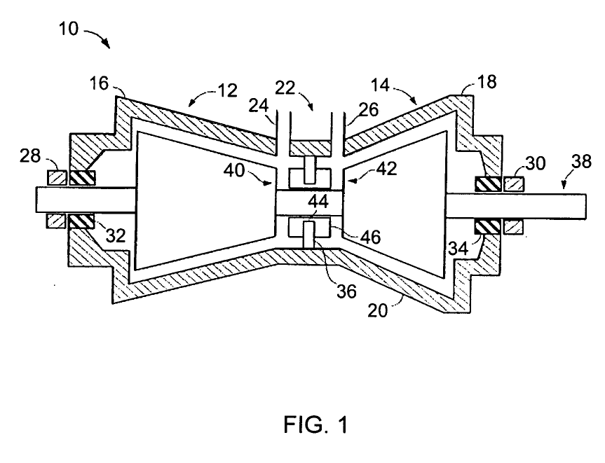

FIG. 1 is a schematic illustration of an exemplary opposed-flow steam turbine 10 including a high pressure (HP) section 12 and an intermediate pressure (IP) section 14. Turbine 10 is shown by way of example only. The present invention can be utilized in connection with many different types of high pressure turbine configurations, and is not limited to practice with any one particular type of high pressure turbine.

With respect to turbine 10, an outer shell or casing 16 is divided axially into upper and lower half sections 18 and 20, respectively, and spans both HP section 12 and IP section 14. A central section 22 of shell 16 includes a high pressure steam inlet 24 and an intermediate pressure steam inlet 26. Within casing 16, HP section 12 and IP section 14 are arranged in a single bearing span supported by journal bearings 28 and 30. A steam seal unit 32 and 34 is located inboard of each journal bearing 28 and 30, respectively.

An annular section divider 36 extends radially inwardly from central section 22 towards a rotor shaft 38 that extends between HP section 12 and IP section 14. More specifically, divider 36 extends circumferentially around a portion of rotor shaft 38 between a first HP section nozzle 40 and a first IP section nozzle 42. Divider 36 is received in a channel 44 defined in packing casing 46. More specifically, channel 44 is a C-shaped channel that extends radially into packing casing 46 and around an outer circumference of packing casing 46, such that a center opening of channel 44 faces radially outwardly.

During operation, high pressure steam inlet 24 receives high pressure/high temperature steam from a steam source, for example, a power boiler (not shown). Steam is routed through HP section 12 wherein work is extracted from the steam to rotate rotor shaft 38. The steam exits HP section 12 and is returned to the boiler wherein it is reheated. Reheated steam is then routed to intermediate pressure steam inlet 26 and returned to IP section 14 at a reduced pressure than steam entering HP section 12, but at a temperature that is approximately equal to the temperature of steam entering HP section 12. Accordingly, an operating pressure within HP section 12 is higher than an operating pressure within IP section 14, such that steam within HP section 12 tends to flow towards IP section 14 through leakage paths that may develop between HP section 12 and IP section 14. One such leakage path may be defined extending through packing casing 46 within rotor shaft 38.

Again, steam turbine 10 is illustrated and described herein by way of example only. The present invention can be utilized in connection with many different types of high pressure turbine configurations, and is not limited to practice with any one particular type of high pressure turbine.

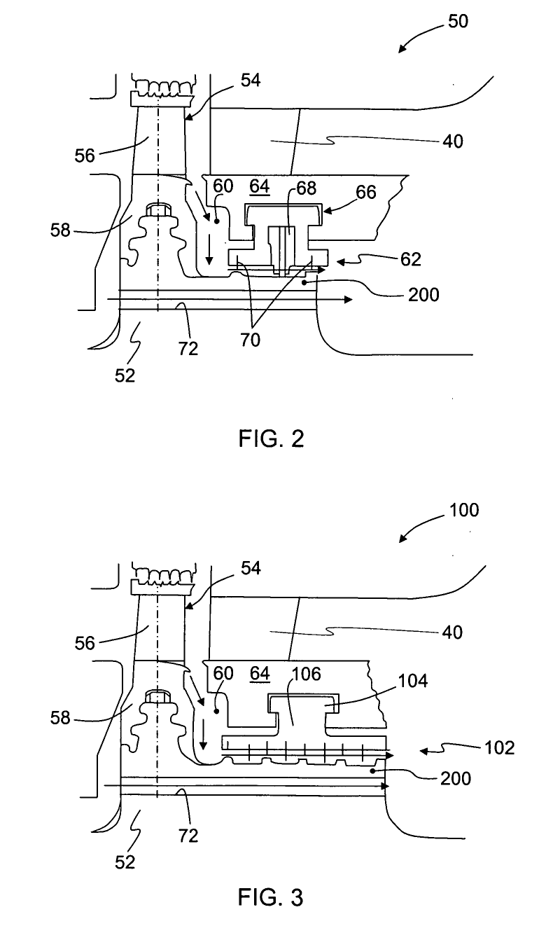

FIG. 2 is a schematic illustration of a portion of a high pressure stage 50. High pressure stage 50 includes a rotor 52 having a bucket assembly 54 secured thereto, and nozzle 40 (shown in FIG. 1). Bucket assembly 54 includes a bucket 56 secured to an attachment fixture 58. In the exemplary embodiment, attachment fixture 58 is a dovetail. As illustrated in FIG. 2, high pressure stage 50 has a high root reaction. A high root reaction can be characterized as any reaction greater than about 0% and less than about 40%. For example, in one embodiment, stage 50 has a high root reaction of about 25% at about 2214 psia. As is known in the art, the root reaction of any stage is established by the design of the stationary and rotating vanes in that region. Such high root reaction facilitates ensuring there is a positive pressure on rotating bucket or blade 56 at all diameters, which in turn facilitates efficient expansion of the steam. Such efficient expansion of the steam facilitates generation of more useful work. However, the pressure between nozzle 40 and bucket 56 is higher than in a lower reaction configuration. As a result, leakage from an intermediate space 60 may increase.

In order to facilitate reduced leakage as compared to known configurations, and in one embodiment, a sealing arrangement or assembly 62 is utilized. Specifically, a root platform 200 forms a partial seal of intermediate space 60. Intermediate space 60 is defined, in part, by attachment fixture 58 and a stationary member 64. A mating stationary seal 66 also is used to partially seal intermediate space 60. In the embodiment illustrated in FIG. 2, stationary seal 66 is shown in the form of a brush seal 68 with conventional teeth 70. Brush seal 68 facilitates minimizing an amount of steam that leaks from intermediate space 60 to an end of stage 50.

In addition, wheel steam balance holes 72 provide a path for shell steam to feed the stage end. Balance holes 72 are sized, in the example embodiment, to be as small as possible yet sufficiently large enough to provide leakage steam from downstream of the bucket.

Sealing arrangement 62 provides that most leakage flow expands through bucket 56 thereby producing useful work prior to leaking to an end of stage 50. In addition, the source pressure driving the leakage will be lower since it will be closer to the shell pressure and lower than the bowl or intermediate pressure. This lower source pressure will also decrease the leakage.

Further, a highly effective seal at the bowl to the end of stage 50 facilitates minimizing leakage from stage 50. The seal can, for example, be in the form of a packing ring, a seal brush, a leaf seal, a variable clearance seal, or any other highly effective seal that facilitates minimizing leakage from stage 50, as described herein.

FIG. 3 is a schematic illustration of an alternative embodiment of a portion of a high pressure stage 100. Components in FIG. 3 that are identical to components in FIG. 2 are referenced in FIG. 3 using the same reference numerals as in FIG. 2. Specifically, high pressure stage 100 includes rotor 52 having bucket 56 secured to attachment fixture 58. As illustrated in FIG. 3, there is a high root reaction that facilitates ensuring there is a positive pressure on rotating bucket or blade 56 at all diameters, which in turn facilitates efficient expansion of the steam.

In the embodiment illustrated in FIG. 3, a sealing arrangement or assembly 102 is utilized. Specifically, root platform 200 forms a partial seal of intermediate space 60. A mating stationary seal 104 also is used to partially seal intermediate space 60. In the embodiment illustrated in FIG. 3, a packing ring seal 106 is shown. Packing ring seal 106 facilitates minimizing an amount of steam that leaks from intermediate space 60 to an end of stage 100. In addition, steam balance holes 72 provide a path for shell steam to feed the stage end.

Sealing arrangement 102 provides that most leakage flow expands through bucket 56 thereby producing useful work prior to leaking. In addition, the source pressure driving the leakage will be lower since it will be closer to shell pressure and lower than the bowl or intermediate pressure. This lower source pressure will also decrease the leakage.

Exemplary embodiments of seal arrangements are described above in detail. The methods, apparatus and systems are not limited to the specific embodiments described herein nor to the specific seal arrangements assembled, but rather, the seal arrangements may be utilized independently and separately from other methods, apparatus, stages, and systems described herein or to assemble seal arrangements not described herein. For example, other seal arrangements can also be assembled using the methods described herein.

While the invention has been described in terms of various specific embodiments, those skilled in the art will recognize that the invention can be practiced with modification within the spirit and scope of the claims.

What is claimed is:

1. A high pressure turbine section, comprising:
at least one stage;
a rotor;
a bucket assembly comprising a bucket and an attachment fixture, said stage having a high root reaction during operation;
an intermediate space between said bucket assembly and a stationary component of said turbine section;
a seal between said stationary member and said rotor to facilitate preventing leakage from said intermediate space toward an end of said section.

2. A high pressure turbine section in accordance with claim 1 wherein the root reaction of said stage is greater than 0%.

3. A high pressure turbine section in accordance with claim 1 wherein said seal comprises a highly effective seal.

4. A high pressure turbine section in accordance with claim 1 wherein said seal comprises a brush seal.

5. A high pressure turbine section in accordance with claim 1 wherein seal comprises a variable clearance seal.

6. A high pressure turbine section in accordance with claim 1 wherein said seal comprises a packing ring seal.

7. A high pressure turbine section in accordance with claim 1 further comprising wheel steam balance holes.

8. A seal assembly for a turbine stage, the turbine including an intermediate space between a bucket assembly, a stationary member and a rotor, said seal assembly comprising:
a seal between the stationary member and the rotor to facilitate preventing leakage from the intermediate space toward an end of the turbine stage; and
wheel steam balance holes providing a path for shell steam to feed the stage end.

9. A seal assembly in accordance with claim 8 wherein said seal comprises a brush seal.

10. A seal assembly in accordance with claim 8 wherein said seal comprises a packing ring seal.

11. A seal assembly in accordance with claim 8 wherein said seal comprises a variable clearance seal.

12. A seal assembly in accordance with claim 8 where the bucket assembly comprises a bucket and a root platform, the turbine stage providing a high root reaction during operation.

13. A rotary machine comprising:
at least one stage;
at least one rotor;
a bucket assembly comprising a bucket and a root platform, said stage having a high root reaction during operation;
an intermediate space between said bucket assembly and a stationary component of said turbine section;
a seal between said stationary member and said rotor to facilitate preventing leakage from said intermediate space toward an end of said section.

14. A rotary machine in accordance with claim 12 wherein the root reaction of said stage is greater than 0%.

15. A rotary machine in accordance with claim 12 wherein said seal comprises a brush seal.

16. A rotary machine in accordance with claim 12 wherein said seal comprises a packing ring seal.

17. A rotary machine in accordance with claim 12 wherein said seal comprises a variable clearance seal.

18. A rotary machine in accordance with claim 12 further comprising wheel steam balance holes.
